(19) United States
(12) Patent Application Publication
(10) Pub. No.: US 2007/0185005 A1
(43) Pub. Date: Aug. 9, 2007

(54) Composition and method

(75) Inventors: Gay Joyce Cornelius, Cottingham (GB); Malcolm Tom McKechnie, Hull (GB)

Correspondence Address: NORRIS, MCLAUGHLIN & MARCUS, 875 THIRD AVE, 18TH FLOOR, NEW YORK, NY, 10022, US

(73) Assignee: RECKITT BENCKISER (UK) LIMITED, Slough, Berkshire (GB)

(21) Appl. No.: 10/597,350

(22) PCT Filed: Feb. 9, 2005
(86) PCT No.: PCT/GB05/00445

§ 371 Date: Aug. 30, 2006

(30) Foreign Application Priority Data
Feb. 11, 2004 (GB) 0403008.6

(51) Int. Cl. C11D 3/37

(52) U.S. Cl. 510/499

(57) ABSTRACT

A cleaning composition comprising from 30 to 70 percent by weight of 1-alkyl-2-pyrrolidone, from 25 to 45 percent by weight of hydrocarbon and from 5 to 25 percent by weight of water exhibits good cleaning performance and a visual indication of activity. The composition is on or adjacent to a phase boundary of its phase diagram and exhibits self-induced surface motility of the Marangoni type.

This invention relates to the field of cleaning. It relates in particular to a cleaning composition, and to a method of cleaning.

EP-A-330379 describes the use of cleaning compositions which contain at least one ether alcohol, water and a hydrocarbon in a single phase, respectively in the percent weight ratios 90-50:2-36:25-0.9. The composition is said to be suitable for removing oil adherent from surfaces e.g. rock cuttings produced during drilling operations for oil. The compositions are made by simply mixing the chemicals, hand shaking, and then allowing the mixture to separate into three phases. The middle phase was the cleaning composition, and was extracted and used for cleaning tests. This middle phase contained the ether alcohol in major proportion, and lesser amounts of water and hydrocarbon.

A disadvantage of this system is the large amount of alcohol ether present in the cleaning composition. The use of large amounts of many alcohol ethers is now restrained by legislation relating to VOCs (Volatile Organic Components).

There is a need for cleansing compositions, with reduced levels of volatile compounds, which clean surfaces, particularly hard surfaces, effectively. There is also a need for cleansing compositions that provide a visual cue to the user that they are working.

In accordance with a first aspect of the present invention there is provided a cleaning composition comprising from 30 to 70 percent by weight of 1-alkyl-2-pyrrolidone, from 25 to 45 percent by weight of hydrocarbon and from 5 to 25 percent by weight of water.

The composition may be in the form of a single phase or it may be present as two or three phases in mutual chemical equilibrium. Where the composition is a single phase, it has the advantage that it does not need to be mixed or shaken prior to use. Where the composition is in the form of 2 or 3 phases, the visual cleaning indication due to motility of the system is more visible. In this case the composition is preferably shaken or mixed prior immediately to use. Preferably the composition is adjacent to a phase boundary on the three-component phase diagram for the composition. By this it is meant that a change in relative weight percentages of the three components of the composition caused by loss of only one component, whereby the weight percentage of that component is reduced by an absolute value of 1% or less, preferably 0.5% or less, more preferably 0.1% or less (expressed as percentage by weight of the total weight of the total composition), leads to a change in the number of phases present in the composition, for instance changing from a single phase to a 2 or 3 phase mixture.

In this specification when a percentage value is given for a component, it denotes the percentage by weight of that component, based on the total weight of the composition of which the component is part.

Compositions of the invention comprise 1-alkyl-2 pyrrolidone. Preferably the alkyl group has, on average, 4 to 16 carbon atoms, more preferably 6 to 14 carbon atoms, and most preferably 8 to 12 carbon atoms. Preferably the alkyl group is linear. 1-octyl 2-pyrollidone is particularly suitable.

The hydrocarbon essential to compositions of the invention is suitably a paraffinic, including isoparaffinic compounds. The hydrocarbon may suitably be a hydrocarbon fragrance. Preferably it is a liquid under ambient conditions. Preferably the hydrocarbon has 5 or more carbon atoms, more preferably 8 or more. Preferably the hydrocarbon has up to 15 carbon atoms, more preferably up to 12 carbon atoms. When the hydrocarbon is a mixture, as will often be the case, these definitions still apply, as mean values.

When a hydrocarbon is present it tends to be lighter than any other phase, and at certain hydrocarbon levels may separate out.

Preferably a hydrocarbon present is significantly more volatile than the water or the amphiphile. By volatile it is meant that a material has a vapour pressure of 0.2 mmHg or more at 20° C.

In this specification when we mention a hydrocarbon it is to be understood that there may be more than one of said hydrocarbon present. The weight percentage definitions denote the total complement of hydrocarbon compounds present.

Compositions of the invention suitably have from 30 to 70 percent by weight of 1-alkyl-2-pyrrolidone, preferably from 40 to 60 percent, more preferably from 45 to 55 percent.

Suitably, compositions of the invention comprise from 25 to 45 percent by weight of hydrocarbon, preferably from 30 to 40 percent, more preferably from 33 to 37 percent.

Suitably, compositions of the invention comprise from 5 to 25% by weight of water, preferably from 10 to 20%.

Suitably the composition may contain an electrolyte, preferably an ionic salt. Suitable examples include alkali metal salts, especially halides. Most preferred, for reasons which include cost and safety, is sodium chloride.

An electrolyte may be used to alter the phase diagram, shifting phrase boundaries so that the composition is on or adjacent to a phase boundary, as preferred by the first aspect of the present invention. When electrolyte is present, it is included with the water, treating-water and electrolyte as a single component for the purpose of drawing up a three component phase diagram.

It is highly preferred for the compositions of the invention to include a fragrance in order to make more acceptable the odour of the compositions in a household cleansing composition. Preferably at least 0.1% by weight of fragrance is present, more preferably 0.4% or more, but preferably 1% or less, more preferably 0.8% or less. The fragrance is included with the hydrocarbon for the purpose of drawing up the three-component phase diagram of the composition. By fragrance is meant perfumer's oil without any base or extender included.

Compositions of the present invention may include low levels, preferably less than 1% by weight of the composition, of conventional adjuncts used in household cleaning products, provided that these do not have a substantial effect on the phase behaviour of the composition. In terms of drawing up a three-component phase diagram for the system, the skilled person would assign such components to be included with the water, amphiphile or hydrocarbon corner of the phase diagram based upon the Hansen solubility parameter for the component. Surfactant, which is a preferred ingredient, at a weight percentage of the composition from 0.01 to 0.1%, more preferably 0.03 to 0.05%, is included with the amphiphile on the phase diagram. Nonionic surfactant, such as alcohol ethoxylate, is particularly preferred when surfactant is present. Biostatic agents such as cationic biostats or suitably PCMX (parachlorometaxylenol) may also be incorporated in compositions of the invention. Bleach systems such as or peroxide-based bleaches may also be used in compositions of the invention.

Remarkably, we have found that compositions of the invention may apparently exhibit behaviour of the Marangoni type. When a jar of a preferred composition of the invention is opened and exposed to the environment the surface may be seen to “twitch”. This effect is believed to be due to surface tension gradients, perhaps allied to crossing of phase boundaries, when volatile compounds evaporate. We have observed such compositions in which, when the lid is replaced on the jar, the “twitching” stops. The “twitching” may be if the composition is pipetted onto a surface.

By twitching we mean that the surface of the composition exhibited motility not induced by an external agent, such as an object applied to it; in other words a self-induced motility.

In accordance with a second aspect of the present invention there is provided a cleaning composition comprising water, a hydrocarbon and 1-alkyl-2-pyrrolidone as detailed hereinbefore, which composition exhibits Marangoni behaviour when exposed to air. Preferably the composition exhibits Marangoni behaviour only when exposed is to air. Preferably the composition is in the form of 2 or 3 phases in mutual equilibrium prior to exposure to the air.

For the purpose of this specification the Marangoni effect may be defined as the effect in a liquid when surface tension gradients cause movement of the liquid. The surface tension gradients may result from concentration changes (Gibbs effect), which may themselves arise from evaporation, or from inadequate mixing, following separation or segregation in a container, or by the application of a stress, for example a shear force (as by a wiping action).

Without wishing to be bound by theory, it is thought that the Marangoni effect may give rise to cleaning benefits exhibited by compositions of the invention. Compositions exhibiting the Marangoni effect may exhibit a tendency to “creep” into small spaces. Evaporation of a compound may lead to changes in surface tension and to surface motility, causing the composition to move, for example into and then out of a crack, drawing soils with it. The use of amphiphiles such as 1-alkyl-2-pyrrolidone may assist separation of dirt from a substrate. Amphiphiles generally do not promote adhesion with a surface but they may wet well. Thus amphiphile-containing compositions which exhibit the Marangoni effect may move into small interstices or may move between a surface and a soil deposit, “lifting” the latter.

In accordance with a third aspect of the present invention there is provided a method of cleaning a soiled substrate, comprising the application to the soiled substrate of a composition of the first and/or second aspect of the present invention, as defined above.

Another aspect of the invention is the use of compositions as described above for household substrate cleaning.

Another aspect of the invention provides a packaged household cleansing composition, wherein the cleansing composition is a composition as described above for the other aspects of the invention.

The substrate may be, for example, a hard surface, for example, a surface in the kitchen or bathroom, including a work surface, floor, tile, glass, sanitaryware item, window, crockery item or a domestic appliance; or a fabric surface, for example a clothing or upholstery item.

The soiling on the substrate may, for example, be grease, a protein stain, wine, fruit juice or make-up.

Preferred compositions of the present invention are provided in containers which have a manually operable pump such as a “trigger spray”, or in containers from which the contents are poured, or expressed by squeezing the container, or in aerosol dispensers. In aerosol dispensers the hydrocarbon of the composition may be the same as the propellant, and evaporation of propellant could itself induce a Marangoni effect.

Containers containing ready-to-use compositions of the invention constitute a further aspect of the present invention, notably containers adapted to deliver such compositions directly to hard surfaces (for example aerosols and “trigger sprays”). Containers containing aqueous dilutable compositions (i.e. comprising the components of the composition without water, the water being added by the user of the product prior to use) constitute a still further aspect. This gives the advantage of reduced packaging and transport costs.

The invention will now be further described, by way of example, with reference to the following example.

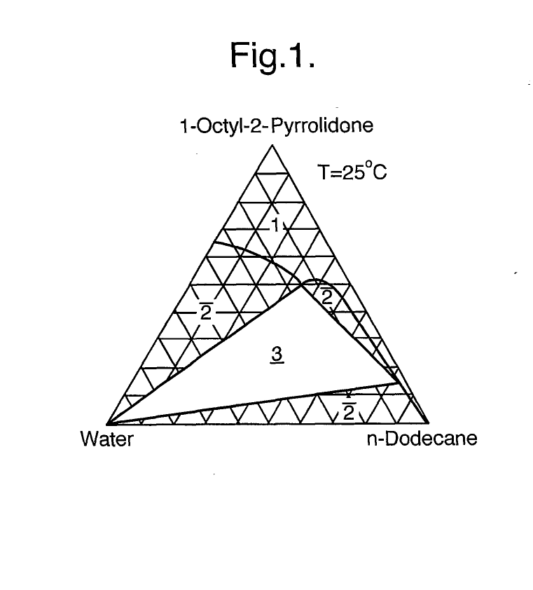

FIG. 1 shows the phase diagram for a system of interest in this invention, 1-(n-octyl)-2-pyrrolidone/n-dodecane/water. It will be seen that this phase diagram also shows phase changes at the water-rich corner, moving from two phases (1-(n-octyl)-2-pyrrolidone/water) to three phases, to two phases (n-dodecane/water). Small changes in the composition, for example induced by preferential evaporation of one component, are again likely to cause the composition to cross a phase boundary.

We believe this is of significance in this system in obtaining a “twitching” effect.

A suitable formulation of the invention which exhibits cleaning and motility has 50% by weight of 1-n-octyl-2-pyrrolidone, 15% by weight of water and 35% by weight of n-dodecane.

1. A cleaning composition comprising from 30 to 70 percent by weight of 1-alkyl-2-pyrrolidone, from 25 to 45 percent by weight of a hydrocarbon and from 5 to 25 percent by weight of water.

2. (canceled)

3. A cleaning composition according to claim 1 wherein the 1-alkyl-2-pyrrolidone has 4 to 16 carbons in its alkyl group.

4. A cleaning composition comprising water, a hydrocarbon and a 1-alkyl-2-pyrrolidone, which composition exhibits Marangoni behaviour when exposed to air.

5. A method of cleaning a soiled substrate, comprising the application to the soiled substrate of a composition according to claim 1.

6. The use of a composition according to claim 1 for the cleaning of household substrates.

7. A packaged household cleaning product comprising a composition according to claim 1.

8. A cleaning composition according to claim 3 wherein the 1-alkyl-2-pyrrolidone is 1-octyl-2-pyrrolidone.

9. A cleaning composition according to claim 1 wherein the hydrocarbon has at least 5 carbon atoms.

10. A cleaning composition according to claim 9 wherein the hydrocarbon has at least 8 carbon atoms.

11. A cleaning composition according to claim 1 wherein the hydrocarbon has up to 15 carbon atoms.

12. A cleaning composition according to claim 1 comprising 40 to 60 percent by weight of 1-alkyl-2-pyrrolidone.

13. A cleaning composition according to claim 1 comprising 30 to 40 percent by weight of a hydrocarbon.

14. A cleaning composition according to claim 1 wherein the composition comprises a plurality of hydrocarbons.

15. A cleaning composition according to claim 1 comprising 10 to 20 percent by weight of water.

16. A cleaning composition according to claim 1 which further comprises an electrolyte.

17. A cleaning composition according to claim 1 which comprise a surfactant, a biostatic agent or a bleach in an amount of up to 1% by weight.

18. A cleaning composition according to claim 1, wherein the water the 1-alkyl-2-pyrrolidone and the hydrocarbon co-exist as a single phase without separating from each other as layers.

19. A cleaning composition according to claim 1 wherein the composition is in the form of 2 or 3 phases.

20. A cleaning composition according to claim 1 wherein the composition exhibits self-induced motility.
